(19) United States
(12) Patent Application Publication
(10) Pub. No.: US 2012/0300302 A1
(43) Pub. Date: Nov. 29, 2012

(54) OPTIMIZED DIELECTRIC REFLECTIVE DIFFRACTION GRATING

(75) Inventors: Nicolas Bonod, La Londe Les Maures (FR); Jean-Paul Chambaret, Chatillon (FR)

(73) Assignees: CNRS(Centre National de la Recherche Scientifique), Paris (FR); ECOLE POLYTECHNIQUE, Palaiseau (FR)

(21) Appl. No.: 13/516,906

(22) PCT Filed: Dec. 13, 2010
(86) PCT No.: PCT/FR2010/052684

§ 371 Date: Aug. 16, 2012

(30) Foreign Application Priority Data
Dec. 17, 2009 (FR) 09 59 157

(51) Int. Cl. G02B 5/18; B29D 11/00

(52) U.S. Cl. 359/569; 216/24

(57) ABSTRACT

A method for producing a reflective diffraction grating. The diffraction grating includes a stack of at least four dielectric material layers, and an upper dielectric material layer that is etched to form grooves of the diffraction grating having a predetermined pitch, The diffraction grating is produced by selecting the number and the nature of the dielectric material layers, digitally computing the reflection and/or transmission efficiencies of at least one of the orders of diffraction of the diffraction grating for a sample of frequencies of the spectral range of use for each of several predetermined diffraction grating configurations while varying the thicknesses of the at least four layers and at least one of the etching parameters of the upper layer, and selecting, from among the computed configurations, at least one configuration depending on the use of the grating.

### FIELD OF THE INVENTION

The present invention relates to a method for obtaining a reflective diffraction grating. More particularly, the invention relates to a method making it possible to obtain an optimized dielectric diffraction grating for use under particular conditions.

The invention also relates to the gratings obtained by that obtainment method.

Preferably, but not exclusively, the invention relates to the obtainment of such an optimized grating to perform a high-power laser beam spectral dispersion.

### BACKGROUND OF THE INVENTION

A diffraction grating is an optical device having periodically spaced grooves. It has a diffraction order number that depends on the incident wavelength, the incidence angle, and its period. In the dispersive orders (different from order 0), the reflection angle depends on the wavelength.

Diffraction gratings are used in many optical systems and, in particular, to amplify laser pulses by frequency drift.

Use of Gratings for Frequency Drift Amplification of Pulsed Lasers

Pulsed lasers, or pulse lasers, make it possible to achieve high instantaneous powers for a very short period of time, in the vicinity of several picoseconds (10⁻¹² s) or several femtoseconds (10⁻¹⁵ s). In these lasers, an ultra-short laser pulse is generated by a laser cavity before being amplified in a lasing medium. The laser pulse initially produced, even with low energy, creates a high instantaneous power, since the energy of the pulse is delivered in an extremely short period of time.

To make it possible to increase the power of the pulsed laser without that instantaneous power damaging the lasing medium, it has been considered to stretch the pulse temporally before amplifying it, then to recompress it. The instantaneous powers used in the lasing medium can thus be decreased relative to the power of the pulse ultimately emitted by the pulsed laser. This frequency drift amplification method (often called “CPA” for “Chirped Pulses Amplification”) makes it possible to increase the duration of a pulse by a factor of approximately 10³, then to recompress it so that it returns to its initial duration.

This CPA method, described in the article by D. Strickland and G. Mourou, “Compression of amplified chirped optical pulses,” (Opt. Commun. 56, 219-221-1985), uses a spectral decomposition of the pulse, making it possible to impose a path with a different length on the various wavelengths to shift them temporally. The stretching and recompression of the pulses are most often done by dispersion gratings, which have significant dispersive powers and good resistance to the laser flow.

Required Characteristics of These Gratings

The diffraction gratings used to implement this method must meet several particular requirements. They must have a very good reflective efficiency in a dispersive order, i.e., they must reflect a very large proportion of the incident light in a dispersive diffraction order, over a spectral interval corresponding to the spectral interval of the laser pulse to be amplified.

Frequency drift amplification also requires diffraction gratings that have excellent resistance to the laser flow, particularly to recompress a laser pulse after it has been amplified.

Dielectric Gratings

Dielectric gratings, as indicated in the article by M. D. Perry, R. D. Boyd, J. A. Britten, B. W. Shore, C. Shannon and L. Li, “High efficiency multilayer dielectric diffraction gratings” (Opt. Lett. 20, 940-942-1995), have better laser flow resistance performance levels than the more efficient metal gratings. They are made up of a stack of thin dielectric layers placed on a substrate and reflecting up to approximately 99% of the incident light. The upper surface is periodically etched to as to obtain the diffraction grating.

The thicknesses of each of the layers of this stack are chosen so as to form a Bragg mirror, or “quarter wave mirror,” in which layers with a high refractive index n_{H} are alternated with layers with a low refractive index n_{L}. The thicknesses t_{H} and t_{L}, respectively, of the high refractive index layers n_{H} and the lower refractive index n_{L} are determined by the following relationships:

$${t}_{H} = \frac{λ}{4 {n}_{H} cos {θ}_{H}}$$

$${t}_{L} = \frac{λ}{4 {n}_{L} cos {θ}_{L}}$$

in which:

λ is the wavelength of the incident light;

θH and θL are calculated by the following relationships:

$${θ}_{H} = {sin}^{- 1} ( \frac{sin {θ}_{i}}{{n}_{H}} )$$

$${θ}_{L} = {sin}^{- 1} ( \frac{sin {θ}_{i}}{{n}_{L}} )$$

in which θi is the incidence angle of the light on the grating. Such a Bragg mirror makes it possible to reflect, owing to constructive interference phenomena, up to more than 99% of the incident energy for a given wavelength.

However, since the thicknesses of the different layers are calculated for a single wavelength λ, they do not make it possible to obtain satisfactory results for pulses having a spectral width larger than approximately 20 nm, centered on that wavelength.

Drawbacks of the Prior Art

These dielectric gratings based on Bragg mirrors, which are satisfactory for the frequency drift amplification of laser pulses with a spectral width in the vicinity of several nanometers, are not adapted to the shortest pulses, which have a larger spectral width.

To decrease the duration of the pulses, it therefore becomes necessary to have diffraction gratings having optimal performance levels over a wide spectral band of several tens, or even several hundreds, of nanometers. No diffraction grating of the prior art guarantees good performance levels over such a spectral width and a high damage threshold.

### AIM OF THE INVENTION

The present invention aims to offset these drawbacks of the prior art.

Thus, the invention aims to provide a method making it possible to obtain an optimized dispersive reflective diffraction grating for a particular use.

In particular, the invention aims to make it possible to obtain an optimized diffraction grating for use over a frequency range several tens, or even several hundreds, of nanometers wide.

The invention particularly aims to make it possible to obtain such an optimized diffraction grating for frequency drift amplification of an ultra-short pulse laser having a spectral width of several hundred nanometers and good resistance to the laser flow.

### BRIEF DESCRIPTION OF THE INVENTION

These aims, as well as others that will appear more clearly hereinafter, are achieved by a method for obtaining a reflective diffraction grating for the diffraction of a light beam with a predetermined spectral range, incidence angle, and polarization, including a stack of at least four planar dielectric material layers, an upper dielectric material layer being etched so as to form a diffraction grating, the etching period of which is predetermined.

This method according to the invention implements the following steps:
selecting the number and the nature of the dielectric material layers, including the etched layer;
digitally computing the reflection and/or transmission efficiencies of at least one of the orders of diffraction for a sample of frequencies belonging to the spectral range of use for each predetermined diffraction grating configuration while varying the thicknesses of at least four of the dielectric material layers and at least one of the etching parameters of the grating in predetermined intervals and with a predetermined incrementation pitch; and
selecting, from among the computed configurations, at least one configuration on the basis of a criterion depending on the provided use of the grating.

Preferably, the non-etched layers of dielectric material are placed on a metal layer, and there are between 5 and 15 of them.

Advantageously, the etching parameters whereof the value varies during the computation step are the etching depth and the groove width.

Advantageously, the digital computation of the reflection and/or transmission efficiencies of at least one of the diffraction orders is done for a sample of at least 10 frequencies distributed in a spectral range with a width larger than 100 nm.

According to one preferred embodiment, this spectral range is between 700 and 900 nm.

The present invention also relates to a reflective diffraction grating including:
a metal layer;
at least two layers of material with a high refractive index and two layers of material with a lower refractive index, alternating; and
an upper layer of dielectric material etched so as to form a diffraction grating. wherein,
   according to the invention, at least two of the layers of material with a high refractive index or the layers of material with a low refractive index have different thicknesses; and
   the thicknesses of the layers of material with a high refractive index and layers of material with a low refractive index, and at least one etching parameter of the upper layer, are determined by a dimensioning method as described above.

Such a diffraction grating is therefore different from those based on a Bragg mirror, in which all of the layers of a same index have the same thickness.

Preferably, this reflective diffraction grating comprises at least two layers of silica (SiO₂) and two layers of hafnium dioxide (HfO₂), alternating, and the etched upper layer is made from silica (SiO₂).

Advantageously, such a reflective diffraction grating, for the diffraction of a light ray with a spectral range between 700 and 900 nm, having an incidence angle between 50° and 56°, comprises a substrate on which at least the following are deposited:
a layer of gold (Au) with a thickness greater than 150 nm;
a layer of silica (SiO₂) with a thickness between 150 nm and 300 nm;
a layer of hafnium dioxide (HfO₂) with a thickness between 150 nm and 300 nm;
a layer of silica (SiO₂) with a thickness between 250 nm and 400 nm;
a layer of hafnium dioxide (HfO₂) with a thickness between 50 nm and 200 nm;
a layer of silica (SiO₂) with a thickness between 50 nm and 200 nm;
a layer of hafnium dioxide (HfO₂) with a thickness between 100 nm and 250 nm;
a layer of silica (SiO₂) with a thickness between 625 nm and 775 nm, etched over the entire thickness thereof so as to form the grating, the etching period d being between 1400 and 1550 lines per mm and the etching width being such that the ratio c/d is equal to 0.65.

According to one advantageous embodiment, such a reflective diffraction grating comprises a layer of alumina deposited between the last layer of hafnium dioxide (HfO₂) and the layer of etched silica (SiO₂).

The invention also relates to a reflective diffraction grating, comprising a substrate on which the following are successively deposited:
a layer of gold (Au);
a layer of silica (SiO₂) with a thickness of 240 nm;
a layer of hafnium dioxide (HfO₂) with a thickness of 240 nm;
a layer of silica (SiO₂) with a thickness of 380 nm;
a layer of hafnium dioxide (HfO₂) with a thickness of 100 nm;
a layer of silica (SiO₂) with a thickness of 100 nm;
a layer of hafnium dioxide (HfO₂) with a thickness of 200 nm;
a layer of alumina (Al₂O₃) with a thickness of 50 nm; and
a layer of silica (SiO₂) with a thickness of 700 nm, etched over the entire thickness thereof.

### PRESENTATION OF THE FIGURES

Other aims, advantages and features of the invention will appear more clearly in the following description of one preferred embodiment, which is not limiting on the subject-matter and scope of the present patent application, accompanied by drawings, in which:

FIG. 1 is a diagrammatic cross-sectional illustration of a diffraction grating according to the prior art, based on a Bragg mirror;

FIG. 2 is a diagrammatic cross-sectional illustration of a diffraction grating according to one embodiment of the invention;

FIG. 3 is a graph showing the reflected efficiency of the diffraction grating shown in FIG. 2, as a function of the wavelength of the incident light;

FIG. 4 is a graph showing the intensity spectrum of a laser pulse with a spectral width of 200 nm and centered on 800 nm, which can be compressed by a device including the diffraction grating of FIG. 2.

### DETAILED DESCRIPTION OF ONE EMBODIMENT OF THE INVENTION

Reminder of the Prior Art

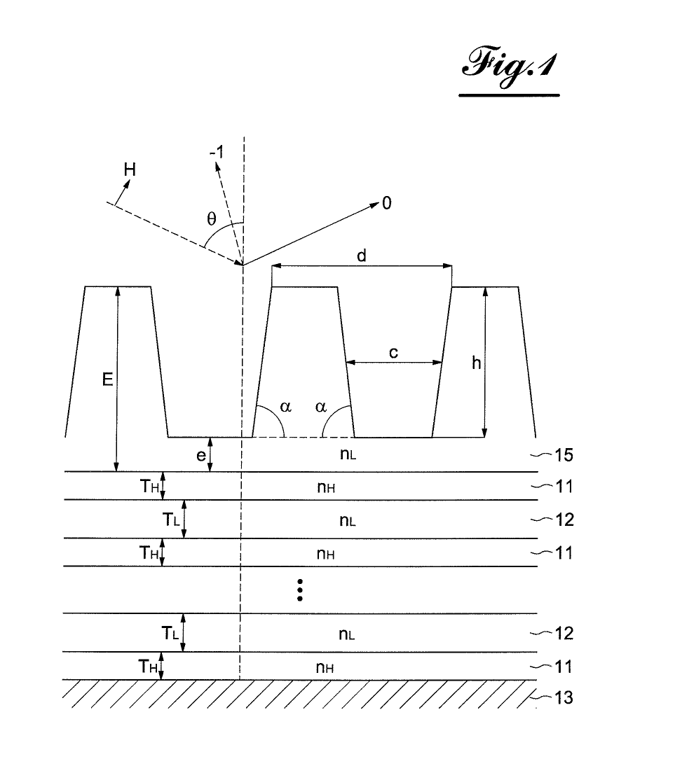

FIG. 1 shows a diagrammatic cross-sectional view of a diffraction grating according to the prior art, based on a Bragg mirror. This grating includes alternating layers 11 with a high refractive index and layers 12 with a low refractive index, deposited on a substrate 13. The thickness of each layer is set as a function of its refractive index n_{H} or n_{L} on the one hand, and the incidence angle θi and wavelength λ of the incident beam on the other hand. In this way, in the Bragg mirror, all of the layers 11 with a high index have an identical thickness, and all of the layers 12 with low indices have an identical thickness.

Dielectric gratings with too many layers present cracking risks when they are exposed to laser flows. To avoid this drawback, a layer of gold (not shown) can be inserted between the glass substrate 13 and the dielectric stack forming a Bragg mirror so as to reduce the number of thin layers needed to obtain a high reflectivity, while guaranteeing a damage threshold close to those obtained with completely dielectric mirrors.

In that case, the thickness of this layer of gold is much larger than the skin thickness, typically 150 nm, such that the glass substrate has no optical interaction with the laser pulse.

The number of dielectric layers above the gold deposit can be set by the user but, contrary to completely dielectric depositions, it is possible to reduce it to six. This solution is described in the article by N. Bonod and J. Neauport, “Optical performances and laser induced damage threshold improvement of diffraction gratings used as compressors in ultra high intensity lasers” (Opt. Commun., Vol. 260, Issue 2, 649-655-2006).

The upper layer 15 is etched to form the grating. The period and the etching geometry are defined so as to collect the greatest portion of the incident energy reflected in the dispersive diffraction order (−1). Only the energy collected in this diffraction order (−1) will be used in the final laser pulse. The energy emitted in the other orders is lost. The period and the etching geometry are generally defined so as to collect approximately 95% of the incident energy reflected in the diffraction order (−1).

Such a grating of the prior art can only offer good performances for a given wavelength, and is in particular not adapted to the dispersion of a laser pulse covering a wide frequency range.

Sizing Methodology

The present invention is based on the joint optimization of the thickness of the planar layers and the etching profile of the grating. The thicknesses of the different layers are therefore not those determined for the Bragg mirrors, but are each optimized, in connection with the characteristics of the etching profile, by a digital optimization method, to have good reflected efficiencies over a wide spectral width.

The grating to be optimized has a certain number of parameters that are chosen before implementing the optimization method. These parameters are primarily:
the number and nature of the layers of dielectric material, the number of layers generally being limited to fewer than 20, and preferably fewer than 15, to avoid cracking risks of the grating, but having to be greater than or equal to 5 so that the grating can have a good reflected efficiency;
the incidence angle of the light pulse on the grating, the spectral width and the polarization of that pulse, which are chosen as a function of the constraints related to the optical system;
the material making up the etched layer;
the etching period d, which is advantageously predetermined, knowing the spectral range and the incidence angle of the laser pulse, such that only the orders 0 (always present) and order (−1) are propagative diffraction orders, the other orders being evanescent; and
the incline angle α of the trapeziums forming the etching profile, which is chosen as a function of the constraints related to the manufacture of the grating.

The optimization is done by choosing the best combination of values for the following variables:
the thickness of each dielectric layer;
the etching depth h, which corresponds to the thickness of the etched layer if the latter is etched over the entire height thereof; and
the width c of the etched groove, the thickness at mid-height of the etched layer.

For each of these values, a minimum and a maximum are determined, as well as an incrementation pitch The minimum and maximum can be chosen in particular as a function of the manufacturing constraints. The incrementation pitch is chosen as a function of the precision of the desired optimization. Furthermore, the incrementation pitch and the [minimum; maximum] intervals are chosen as a function of the computation power available to perform the optimization. The number of computations in fact increases when the intervals are increased or when the incrementation pitches are decreased.

The diffraction grating having these parameters can be dimensioned, according to the invention, with the method comprising the following steps:

A plurality of possible configurations of the diffraction grating are determined corresponding to the aforementioned parameters. To that end, a computer is used to determine all possible combinations by varying the thicknesses of each of the layers of dielectric material and the etching parameters of the upper layer within predetermined intervals and according to the predetermined pitches.

For each of the configurations determined in the first step, the reflected efficiency is computed in the diffraction order (−1) of the grating, for a sample of frequencies chosen in the spectral range of use for the grating to be dimensioned.

After computing the efficiency of each of the configurations, the configuration(s) whereof the efficiencies and characteristics best correspond to the anticipated use of the diffraction grating are selected, using a suitable criterion.

It should be noted that the values of some of the variables can be set, to simplify the computations or if it is not relevant to optimize them. Thus, for example, it is possible to set the thickness of a dielectric layer that does not have a substantial optical effect, such as a fine layer of alumina (Al₂O₃) present to meet mechanical constraints. The optimization according to the invention can only, however, be done by simultaneously optimizing at least one of the etching parameters (etching height h, incline angle α of the trapeziums, width c of the etched groove) and the thickness of each of the dielectric layers having a significant optical effect, of which there are at least four.

In a novel manner, this digital optimization method therefore takes into account both the thicknesses of each of the layers foaming the grating, and the etching characteristics of that grating.

To determine the plurality of possible configurations, in the case where there are six layers of dielectric materials in addition to the etched layer, software is used that will use the following variables:
height h of the etched layer,
thickness e1 of the first layer,
thickness e2 of the second layer,
thickness e3 of the third layer,
thickness e4 of the fourth layer,
thickness e5 of the fifth layer,
thickness e6 of the sixth layer, and
groove width c.

The following parameters are entered into the software:
minimum hₘᵢₙ and maximum hₘₐₓ height of the etched layer, and incrementation pitch Δh of the variable h;
minimum e1ₘᵢₙ and maximum e1ₘₐₓ thickness of the first layer, and incrementation pitch Δe1 of the variable e1;
minimum e2ₘᵢₙ and maximum e2ₘₐₓ thickness of the second layer, and incrementation pitch Δe2 of the variable e2;
minimum e3ₘᵢₙ and maximum e3ₘₐₓ thickness of the third layer, and incrementation pitch Δe3 of the variable e3;
minimum e4ₘᵢₙ and maximum e4ₘₐₓ thickness of the fourth layer, and incrementation pitch Δe4 of the variable e4;
minimum e5ₘᵢₙ and maximum e5ₘₐₓ thickness of the fifth layer, and incrementation pitch Δe5 of the variable e5;
minimum e6ₘᵢₙ and maximum e6ₘₐₓ thickness of the sixth layer, and incrementation pitch Δe6 of the variable e6; and
minimum eₘᵢₙ and maximum cₘₐₓ groove width, and incrementation pitch Δc of the variable c.

The software initializes each of the variables h, e1, e2, e3, e4, e5, e6, and c at their respective minimum values hₘᵢₙ, e1ₘᵢₙ, e2ₘᵢₙ, e3ₘᵢₙ, e4ₘᵢₙ, e5_{min, e}6ₘᵢₙ, and cₘᵢₙ. The reflected efficiency of this first configuration is then computed using the appropriate method for resolving the Maxwell equations.

The first parameter h is incremented by the value of the pitch Δh, while its value is less than or equal to hₘₐₓ. For each of the values assumed by h, the reflected efficiency of the corresponding configuration is computed using the appropriate method for resolving the Maxwell equations.

The second parameter e1 is incremented by the value of the pitch Δe1, while its value is less than or equal to e1ₘₐₓ. For each of the values assumed by e1, the value of h is varied as described above and the reflected efficiency of all of the corresponding configurations is computed using the appropriate method for resolving the Maxwell equations.

The third parameter, then each of the following parameters, is thus incremented until the reflected efficiencies of all of the possible grating configurations whereof the parameters h, e1 , e2, e3, e4, e5, e6, and c are between the set minimum and maximum values, with the set incrementation pitches, have been computed.

Thus, if the following parameters are entered:
hₘᵢₙ=300 nm, hₘₐₓ=800 nm, Δh=10 nm, or 51 possible values of h;
e1ₘᵢₙ=0 nm, e1ₘₐₓ=200 nm, Δe1=10 nm, or 21 possible values of e1;
e2ₘᵢₙ=100 nm, e2ₘₐₓ=300 nm, Δe2=10 nm, or 21 possible values of e2;
e3ₘᵢₙ=0 nm, e3ₘₐₓ=200 nm, Δe3=10 nm, or 21 possible values of e3;
e4ₘᵢₙ=100 nm, e4ₘₐₓ=300 nm, Δe4=10 nm, or 21 possible values of e4;
e5ₘᵢₙ=0 nm, e5ₘₐₓ=200 nm, Δe5=10 nm, or 21 possible values of e5;
e6_{n,} _{n =100 nm, e}6ₘₐₓ=300 nm, Δe6=10 nm, or 21 possible values of e6; and
cₘᵢₙ/d=0.55, cₘₐₓ/d=0.75, Δc/d=0.1 (the etching period d being set), or 3 possible values of c; wherein the number of configurations for which the reflected efficiency is computed is equal to:
3×51×(21)⁶=13,122,216,513 configurations.

Computation of the Reflected Efficiency

For each of these configurations, the reflected efficiency of the grating can be computed for several previously-selected wavelengths, distributed in a given frequency range.

The method for computing the reflected efficiency in the diffraction order (−1) of the configuration of each configuration of the grating, based on a rigorous resolution of the Maxwell equations, rests on the development of the electric and magnetic fields in a Fourier series, which makes it possible to reduce the Maxwell equations to a system of differential equations of the 1^{st} order. Integrating this system of the substrate into the superstrate makes it possible to precisely compute the reflection and transmission efficiencies of the periodic component. A second integration makes it possible to reconstruct the electromagnetic field in the entire space.

This computation method is fully described in the work by M. Nevière and E. Popov, entitled “Light propagation in periodic medias; differential theory and design” (Marcel Dekker, New York, Basel, Hong Kong, 2003).

Once this reflection calculation in the −1 order is done for all of the configurations, it is possible to choose the configuration(s) having both good reflected efficiencies and characteristics compatible with the anticipated use of the diffraction grating.

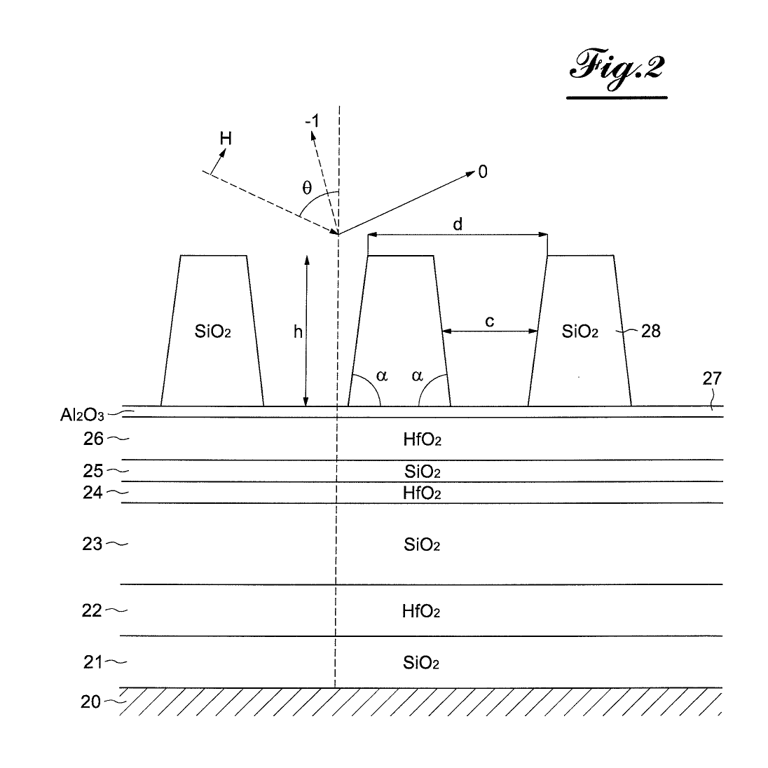

Parameters Chosen to Obtain the Grating of FIG. 2

The diffraction grating shown in FIG. 2 is intended for the frequency drift amplification of a laser pulse of the femtosecond type amplified by a titanium-sapphire crystal, having a spectral amplitude of 200 nm centered on 800 nm, and an ET (electric transverse) polarization. FIG. 4 is a measurement of the spectral intensity of this laser pulse. The incidence angle of the light on the grating is set at 55°, and the etching frequency 1/d of the grating is set at 1480 lines per mm.

The incline angle α of the trapeziums forming the etching is chosen at 83°. This angle is closest to the angles measured on the gratings currently made by manufacturers in this type of oxide, and for this type of depth.

It has been chosen to manufacture this grating with three planar layers 21, 23, and 25 of SiO₂, alternating with three planar layers 22, 24, and 26 of HfO₂, the lower layer 21 of HfO₂ being placed on a layer of gold 20.

For each planar layer 21, 23, or 25 of SiO₂, the chosen incrementation pitch is 10 nm in an interval of [100; 400] nm.

For each planar layer 22, 24 and 26 of HfO₂, the chosen incrementation pitch is 10 nm in an interval of [0; 300] nm.

An additional upper layer 28 of SiO₂ is etched over the entire height thereof.

A layer 27 of Al₂O₃ with a thickness of 50 nm is provided between the upper layer 28 of SiO₂ intended to be etched and the upper layer 26 of HfO₂ to facilitate the etching of the layer 28 of SiO₂ over the entire thickness thereof without damaging the layer 26 of HfO₂. This fine layer 27, when it is indispensable to produce the grating, is taken into account in the computations of the reflected efficiency of the grating as a constant. This layer of Al₂O₃ could, of course, not be used, or could be placed in another position, in other embodiments of the invention.

The interval chosen for the c/d parameter is [0.55; 0.75], with an incrementation pitch of 0.1.

The interval chosen for the etching depth h (which, in this embodiment, corresponds to the thickness of the etched layer) is [300; 800] nm, with an incrementation pitch of 10 nm.

The reflected efficiency in the order −1 is computed for 41 wavelengths comprised between 700 nm and 900 nm.

As a function of the chosen parameters, the number of computations of the reflected efficiency of the different possible configurations of the diffraction grating is therefore 41*3*51*[31]ⁿ, where n is the number of planar layers, or 6.

It should be noted that the number of wavelengths for which the reflected efficiency in the order −1 can rise to several hundred for a fine optimization.

Optimization of the Grating Parameters

The computation of the reflected efficiency in order −1 of all of these configurations is done by computer, using the computation method described above.

This method can of course be used iteratively. Thus, when a first implementation of the method makes it possible to detect optimized grating solutions, one or more new implementations with differently chosen intervals and reduced incrementation pitches make it possible to precisely define the best grating solutions.

Using the sizing method according to the invention thus makes it possible to find different grating configurations, having the parameters described above relative to FIG. 2, which make it possible to obtain, with an etching depth in the vicinity of 700 nm, reflected efficiency averages in order −1 greater than 90% in the [700; 900] nm spectral interval.

One of these configurations corresponds to a grating made up of a glass substrate, on which are successively deposited:
a layer of gold 20 whereof the thickness is much larger than the skin thickness, typically 150 nm, such that the glass substrate has no optical interaction with the laser pulse.
a layer 21 of silica (SiO₂) with a thickness of 240 nm;
a layer 22 of hafnium dioxide (HfO₂) with a thickness of 240 nm;
a layer 23 of silica (SiO₂) with a thickness of 380 nm;
a layer 24 of hafnium dioxide (HfO₂) with a thickness of 100 nm;
a layer 25 of silica (SiO₂) with a thickness of 100 nm;
a layer 26 of hafnium dioxide (HfO₂) with a thickness of 200 nm;
a layer 27 of alumina (Al₂O₃) with a thickness of 50 nm; and
a layer 28 of silica (SiO₂) with a thickness of 700 nm, which is subsequently etched over the entire thickness thereof so as to form the grating.

The etching is done so that the value of c/d is equal to 0.65.

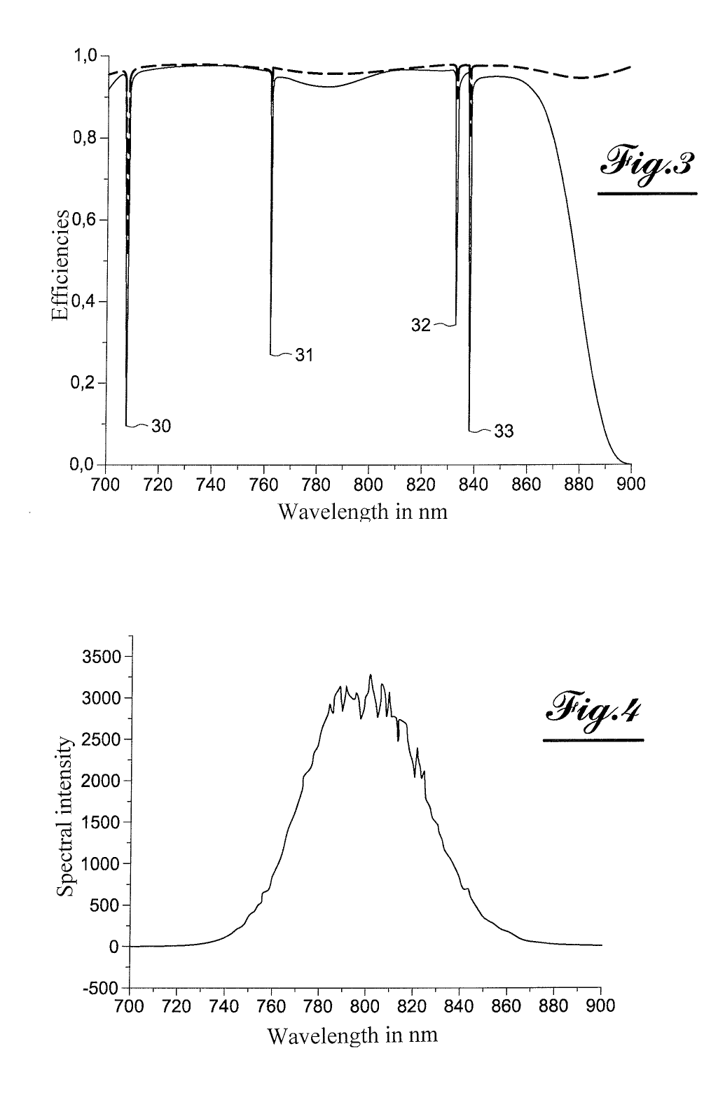

FIG. 3 is a graph showing on the one hand, in solid lines, the reflected efficiency of this grating in the −1 order, and, on the other hand, in broken lines, the sum of the reflected efficiencies (order 0+order −1) of this grating, as a function of the wavelength of the incident light.

The etching parameters have been chosen so that the number of diffraction orders is limited to two (order −1 and order 0) so as to limit the distribution of the energy in too many orders. The order 0 not being dispersive (the diffraction angle in that order does not depend on the frequency), the order (−1) in which the incident light is dispersed.

The graph of FIG. 3 shows that minimums 30, 31, 32, and 33 appear, but that their spectral width is very subtle, such that they do not affect the reflected efficiency average calculated over the spectral range.

FIG. 4 shows, as an example, the spectral intensity of the laser pulse that must be reflected by the grating of FIG. 2. The criterion used to select the grating is the average reflected efficiency of the grating, weighted by the spectral intensity of the incident wave shown in FIG. 4. This average, computed over 801 points regularly distributed over the entire spectral range [700 nm; 900 nm], is equal to 94.5% for the grating of FIG. 2.

The grating sized using this method can then be manufactured by using the traditional manufacturing methods, known by those skilled in the art to manufacture gratings based on Bragg mirrors.

Intervals Allowing the Best Reflected Efficiencies

By using this sizing method, it is possible to determine intervals in which the thicknesses of the layers of a grating having six layers of SiO₂ and HfO₂ in addition to the etched layer must be located so that the reflected efficiency average in the order −1 of a laser pulse, for example amplified by a material of the Titanium-Sapphire type, with a spectral width of approximately 200 nm centered on 800 nm, arriving on the grating with an incidence comprised between 50° and 56°, is greater than 90%.

The etching depth of this grating is comprised between 625 nm and 775 nm, and the number of lines per mm is comprised between 1400 and 1550.

The intervals in which the thicknesses of the layers are comprised are:
Layer 1 (SiO2): [150; 300] nm;
Layer 2 (HfO2): [150; 300] nm;
Layer 3 (SiO2): [250; 400] nm;
Layer 4 (HfO2): [50; 200] nm;
Layer 5 (SiO2): [50; 200] nm; and
Layer 6 (HfO2): [100; 250] nm.

Using a grating having these features is therefore particularly advantageous, in particular to compress a laser pulse amplified by a material of the Titanium-Sapphire type.

1. A method for producing a reflective diffraction grating for diffraction of a light beam with a predetermined spectral range, incidence angle, and polarization, the diffraction grating including a stack of at least four planar dielectric material layers, and an upper layer at a top of the stack, the upper layer including grooves forming the diffraction grating, wherein the grooves in the upper layer are formed by etching of the upper layer and are arranged with a predetermined pitch, the method comprising:
selecting the number and materials of the dielectric material layers, including the upper layer;
digitally computing at least one of reflection and transmission efficiencies of at least one of the orders of diffraction of the diffraction grating for a sample of frequencies of the spectral range of use for each of a plurality of predetermined diffraction grating configurations, while varying thicknesses of the at least four dielectric material layers and at least one of etching parameters of the upper layer, in predetermined intervals, and with a predetermined increment in the pitch of the grooves; and
selecting, from among the diffraction grating configurations that are computed, at least one diffraction grating configuration depending on use of the diffraction grating.

2. The method for producing a diffraction grating according to claim 1, including forming the stack of dielectric material layers to include at least 5 and no more than 15 dielectric material layers on a metal layer, wherein at least some of the dielectric material layers are not etched and the dielectric material layers that are not etched are placed on the metal layer.

3. The method for producing a diffraction grating according to claim 1, wherein the etching parameters are etching depth and groove width.

4. The method for producing a diffraction grating according to claim 1, including digitally computing at least one of the reflection and transmission efficiencies for at least one of the orders of diffraction for a sample of at least 10 frequencies distributed in a spectral range with a width larger than 100 nm.

5. The method for producing a diffraction grating according to claim 4, wherein the spectral range is between 700 and 900 nm.

6. A reflective diffraction grating including:
a metal layer;
at least two layers of a material with a relatively high refractive index and two layers of a material with a relatively low refractive index, lower than the relatively high refractive index, with the layers with the relatively high refractive index alternating with the layers with the relatively low refractive index;
an upper layer of a dielectric material including grooves forming a diffraction grating; wherein
the grooves in the upper layer of a dielectric material are formed by etching,
at least two of the layers with a relatively high refractive index or the layers with a relatively low refractive index have different thicknesses, and
the thicknesses of the layers with a relatively high refractive index and the layers with a relatively low refractive index, and at least one etching parameter of the upper layer, are determined by the method according to claim 1.

7. The reflective diffraction grating according to claim 6, comprising at least two layers of silica and two layers of hafnium dioxide, alternating, and wherein the upper layer is silica.

8. The reflective diffraction grating according to claim 7, for the diffraction of light with a spectral range between 700 and 900 nm; and having an incidence angle between 50° and 56°, comprising:
a substrate; and
a layer of gold with a thickness greater than 150 nm, disposed on the substrate, wherein the at least four dielectric material layers and the upper layer comprise, on the layer of gold,
a first layer of silica with a thickness between 150 nm and 300 nm,
a first layer of hafnium dioxide with a thickness between 150 nm and 300 nm,
a second layer of silica with a thickness between 250 nm and 400 nm,
a second layer of hafnium dioxide with a thickness between 50 nm and 200 nm,
a third layer of silica with a thickness between 50 nm and 200 nm,
a third layer of hafnium dioxide with a thickness between 100 nm and 250 nm,
a fourth layer of silica with a thickness between 625 nm and 775 nm, as the upper layer and etched entirely through the thickness to form the diffraction grating, the inverse of the pitch of the grooves being 1400 to 1550 lines per mm and the grooves having a width that the ratio of the width to the pitch is equal to 0.65.

9. The reflective diffraction grating according to claim 8, including a layer of alumina between the third layer of hafnium dioxide and the fourth layer of silica.

10. The reflective diffraction grating according to claim 7, comprising
a substrate; and
a layer of gold on the substrate, wherein the at least four dielectric material layers and the upper layer comprise, on the layer of gold,
a first layer of silica with a thickness of 240 nm,
a first layer of hafnium dioxide with a thickness of 240 nm,
a second layer of silica with a thickness of 380 nm,
a second layer of hafnium dioxide with a thickness of 100 nm,
a third layer of silica with a thickness of 100 nm,
a third layer of hafnium dioxide with a thickness of 200 nm,
a fourth layer of alumina with a thickness of 50 nm, and
a fourth layers of silica with a thickness of 700 nm, as the upper layer and etched entirely through the thickness to form the diffraction grating.
